(19) United States
(12) Patent Application Publication
(10) Pub. No.: US 2026/0367021 A1
(43) Pub. Date: Nov. 19, 2026

(54) CALIBRATION APPARATUS FOR A MEASUREMENT DEVICE, AND METHOD FOR CALIBRATING A MEASUREMENT DEVICE

(71) Applicant: Helmut Fischer GmbH Institut fuer Elektronik und Messtechnik, Sindelfingen (DE)

(72) Inventor: Martin Leibfritz, Deckenpfronn (DE)

(21) Appl. No.: 19/102,112

(22) PCT Filed: Jul. 5, 2023
(86) PCT No.: PCT/EP2023/068508

§ 371 Date: Feb. 7, 2025

(30) Foreign Application Priority Data
Aug. 8, 2022 (DE) 10 2022 119 877.4

(51) Int. Cl. G01N 23/223; G01B 15/02

(52) U.S. Cl. CPC G01N 23/223; G01B 15/025; G01N 2223/3037

(57) ABSTRACT

The invention relates to a calibration apparatus for a measurement device and to a method for calibrating the measurement device for the purpose of analyzing materials or layer thicknesses using a calibration apparatus (11), consisting of a housing (12) with a carrier (18) comprising a plurality of sections (28, 29, 30), wherein at least one calibration standard (34) is provided in at least one section (28), having a drive (16) which can be used to alternately or transfer the sections (28, 29, 30) of the carrier (18) into a measurement position (49), having a controller (17) which controls the drive (16) to move the carrier (18), and having a data interface (26) which is connected to the controller (17) and is provided for the purpose of communicating with the measurement device (42).

The invention relates to a calibration apparatus for a measurement device and a method for calibrating a measurement device with such a calibration apparatus for material or coating thickness analysis.

DE 10 2005 054 589 B4 describes a calibration apparatus for the non-destructive calibration of measuring devices for the non-destructive measurement of the thickness of thin layers is known. This calibration apparatus comprises a carrier plate made of a base material and several calibration standards applied to the carrier plate. The individual calibration standards have different layer thicknesses to which the measurement device is to be calibrated. It is intended that the measurement device is placed on the carrier plate with a base and the measuring probe of the measurement device is placed on the selected calibration standards in succession in order to carry out the calibration. This This calibration can increase the measuring accuracy of the measuring device. Once the measurement device has been calibrated, the individual measurements are carried out on measurement objects in accordance with the measurement task.

Furthermore, measuring devices are known that enable material analysis using X-ray fluorescence, for example to determine different proportions of elements in a material or coating. Furthermore, measuring devices enable coating thickness analysis using X-ray fluorescence. For such measuring devices for material or coating thickness analysis, it is necessary for these measuring devices, which have an X-ray fluorescence device, to be calibrated.

The calibration of such measuring devices requires an increased amount of time for calibration due to the performance of several measurements on calibration standards that differ from each other and a subsequent reconstruction time, which occupies the operating personnel of such a measurement device in order to measure a given batch of measurement objects. In addition, manual calibration by placing the calibration standard on the measurement device may entail the risk that the calibration is not performed in the isocenter of the measuring device, which may result in calibration errors that lead to lower measurement quality.

The invention is based on the task of proposing a calibration apparatus for a measurement device for material analysis or coating thickness analysis, by means of which an improved calibration for increasing the measuring accuracy of the calibrated measuring devices is made possible. Furthermore, the invention is based on the task of proposing a method for calibrating a measurement device for material or coating thickness analysis, which enables increased precision of the calibration and improved measuring accuracy of the measurement device for the subsequent measuring task.

The problem underlying the invention is solved by a calibration apparatus for a measuring device, in particular an X-ray fluorescence measuring instrument, for material analysis or coating thickness analysis, which has a housing with a carrier which comprises a plurality of sections, at least one calibration standard being provided in at least one section, and with a drive by means of which the sections of the carrier can be moved alternately or successively into a measuring position, and with a controller provided in the housing which controls the drive for positioning the carrier in the measuring position, by means of which the sections of the carrier can be moved alternately or successively into a measuring position, and with a controller provided in the housing, which controls the drive for positioning the carrier in the measuring position, and with a data interface, by means of which the controller of the calibration apparatus communicates with a data interface of a control device of the measuring instrument to be calibrated.

The calibration apparatus is preferably designed separately from the measurement device and/or as an independent component of the measuring device. Such a calibration apparatus enables at least one section of the carrier, which accommodates or has a calibration standard, to be transferred to a measuring position on or in the measurement device in order to subsequently carry out a measurement of the measurement device to be calibrated, in which the X-ray radiation of the measurement device is directed onto the calibration standard in order to detect a calibration value. Through the communication of the measurement device with the calibration apparatus via the respective data interface, the carrier can be successively or alternately transferred to the respective measuring position with respect to its sections via the control in the calibration apparatus, so that, for example, a corresponding number and/or selection of calibration standards, which were selected by the control device of the measurement device on the basis of the subsequent measuring task, can be successively transferred to the measuring position in order to carry out the calibration of the measuring device. This ensures that the calibration standard arranged at least in the section of the carrier can be transferred to the measuring position with repeat accuracy, so that the measurement in the measurement device for the calibration is aligned with the center of the calibration standard or the isocenter. This enables improved calibration and therefore more precise measurement accuracy for the measurement device to be calibrated. Once the measurement device has been calibrated, the calibration apparatus can be used for a subsequent measurement device to be calibrated.

It is preferable for the carrier to have several sections arranged in a row, which can be transferred to the measuring position one after the other. This enables simple control of the calibration apparatus and time-saving execution of the calibration using measuring devices by the calibration apparatus.

Advantageously, it can be provided that each section of the carrier has an identification code which can be read by an optical camera of the calibration apparatus or the measurement device and the control system can transfer the respective identified section to the measuring position. This, preferably individualized, identification code can be, for example, a QR code or a one-dimensional code, such as a barcode, as well as any combination of numbers and/or figures. By detecting the identification code in the optical camera, the respective calibration standard assigned to the section can then be selected and transferred to the measuring position for calibrating the measuring device. This can increase the process reliability for calibrating the measuring device.

Alternatively, it can be provided that the drive for controlling a traversing movement of the carrier of the calibration apparatus has a position sensor and one of the sections is aligned with the position sensor in a start position or initial position and the other sections can be controlled in a defined manner by detecting the angle of rotation or increments of the position sensor and can be transferred to the respective measuring position. This can enable alternative control and alignment of the individual sections of the carrier to the measuring position. Furthermore, the carrier can alternatively be provided with indexing, which is queried by the controller in the housing and from which a zero position or a start position is detected in order to subsequently transfer the travel movement of the carrier to the respective section in the measuring position, knowing the respective position of the sections in relation to each other.

According to a preferred embodiment of the calibration apparatus, the carrier is designed as a rotating disk which has several sections distributed around its circumference. These sections are preferably in the form of a piece of cake.

It is advantageous that the sections arranged around the circumference are evenly distributed on the carrier. For example, two, four, six, eight or twelve sections can be provided on a carrier or twelve sections can be provided in order to accommodate a minimum number of calibration standards. For example, calibration standards made of the pure elements gold, silver, platinum, lead and/or chromium can be provided for the material analysis of a precious metal, such as for determining the components or elements in fine gold.

According to a further preferred embodiment of the carrier, it is provided that individual sections have a receptacle for positioning a calibration standard. Such calibration standards are preferably manufactured in accredited test laboratories and provided as a coated base material or consisting of a foil. The carrier can be individually equipped with such calibration standards for the respective calibration task. A holder for aligning the calibration standard is preferably provided for the correct positioning of the calibration standards in the section. Alternatively, a support surface can be provided in the section of the carrier, on which the calibration standard can be positioned.

Furthermore, it may be provided that the carrier has a predetermined number of sections or that all sections have a fixed configuration with calibration standards that differ from one another. This means that a pre-assembled carrier or a pre-assembled calibration apparatus can be designed for specific measuring tasks of the measuring device.

Furthermore, it is preferable for the carrier to be interchangeable with the drive in the housing. This allows the calibration apparatus to be quickly and easily converted for different calibration tasks. Advantageously, a storage space can be provided in the housing in which the individual carriers can be stored.

According to a further preferred embodiment of the calibration apparatus, it is provided that the carrier has a pinhole aperture in at least one section. This enables, for example, a measurement object to be aligned with the pinhole and a measurement to be carried out by the measurement device and then the carrier plate to be transferred to a further measurement position in which the section of the carrier arranged in the measurement position is positioned with a calibration standard or a verification standard that is not used for calibration. This allows a comparison to be made between the measured values of the measurement object and the calibration standard and/or verification standard in order to determine whether the measurement performed on the measurement objects is within a defined limit range or below a predetermined threshold value.

Furthermore, it may preferably be provided that the carrier has a perforated panel covered with a film in at least one of the sections. In particular, the film is designed as a Mylar film. This allows small objects to be placed in the section whose surface area is smaller than the aperture. Such Mylar films are invisible to X-rays, i.e. the Mylar film does not contain any components that would interfere with the primary radiation and the secondary radiation emitted by the object to be measured in the X-ray fluorescence range.

The carrier of the calibration apparatus is preferably made of a low-reflection, in particular reflection-free and/or at least low-absorption, in particular absorption-free material for X-rays. In particular, a plastic material free of additives is provided. For example, the carrier can be made of a thermoplastic material, in particular polyethylene, polycarbonate or polymethyl methacrylate.

The data interface provided on the housing of the calibration apparatus is preferably designed for wireless communication with the measurement device to be calibrated. Conventional standards, such as WiFi or Bluetooth or similar, can be used. Alternatively, the data interface on the housing of the calibration apparatus can also be designed for wired communication with the measuring device. This can be, for example, known USB interfaces and their variants.

Furthermore, it is preferable that the carrier in the housing is accommodated by an axis rotatable to an X/Y plane, which is rotatable parallel to a measuring surface of the measuring device. This allows the individual sections to be gradually transferred to a measuring point in the measuring surface of the measuring device, which is exposed to X-rays by an X-ray fluorescence device in the measuring device.

Furthermore, it is preferable for the carrier to protrude with an arcuate segment-shaped section opposite an end face of the housing. This protruding arc-segment-shaped section can be aligned with a measuring point in the measuring surface of the measuring device. The calibration standard, the identification code, the pinhole aperture and/or the pinhole aperture covered with a foil are provided in the respective section of the arcuate segment-shaped section that protrudes from the housing. Alternatively, it may be provided that the carrier is completely rotatable within the housing in an X/Y plane and arranged parallel to the measuring surface of the measuring device. Advantageously, the housing has a housing opening on the wall section facing the measuring surface of the measuring device.

Furthermore, it is preferred that the housing of the calibration apparatus has a support surface or support points and that the plane of the support surface or the support point and a measuring point or a measuring surface of the calibration standard or the measurement object on or on the carrier are less than 10 mm apart, preferably less than 5 mm, preferably less than 3 mm. Especially for calibration standards with thin layers that are used for calibration, a small distance is advantageous for achieving maximum intensity in the secondary radiation.

According to a further preferred design of the calibration apparatus, the calibration standards are designed as pure elements or as layered elements consisting of a base material and a coating. In the case of a precious metal such as gold, pure elements are understood to mean a purity of more than 99% gold. The same applies to other precious metals.

The problem underlying the invention is further solved by a method for calibrating a measurement device for material or coating thickness analysis, in particular an X-ray fluorescence measuring device, in which a measurement task to be performed subsequently is called up and selected in a control device of the measuring instrument and in which a calibration apparatus is transferred to a calibration position for the measuring instrument in accordance with one of the embodiments described above and in which individual calibration standards arranged in the sections of the carrier are moved to a measurement position in which the selected section of the carrier is aligned with the measurement point in the measurement surface of the measuring instrument and in which measurement data from the calibration standards arranged in the respective sections of the carrier are forwarded to a control device and a calibration value is determined from the measurement data of each calibration standard and in which the standard values stored in the control device are compared with the recorded calibration values and correction values for subsequent measurement tasks with the measurement device are determined and used as a basis. This method has the advantage that the operating personnel can turn their attention to other activities during the calibration of the measuring device, as the calibration of the measurement device for the subsequent measuring task is carried out by the calibration apparatus. This also eliminates operating errors, for example if calibration standards are mixed up or are not aligned in the isocenter of the measuring point in the measuring surface of the measuring device.

Preferably, it is provided that the at least one section of the carrier of the calibration apparatus is aligned with the measuring point of the measurement device for assuming the calibration position. Preferably, the calibration apparatus can be positioned on the measuring surface of the measurement device in order to subsequently carry out an adjustment in the alignment of the at least one section of the carrier to the measuring point in the measuring surface of the measuring device.

In particular, it is intended that the alignment of the calibration standard in the section of the carrier to the measuring point in the measuring surface of the measurement device is indicated by a positioning laser of the measurement device or shown in a display of the measurement device with a measuring image camera that captures the measuring point. This makes it easy to ensure that the calibration position is taken.

Furthermore, it is preferable that communication is established between the calibration apparatus and the measurement device in the calibration position via the data interface of the calibration apparatus and the control device in the measuring device. For example, it may be necessary to actively couple the calibration apparatus to the measurement device the first time it is positioned, particularly in the case of wireless communication. During a subsequent or further calibration, secure and wireless communication can be established independently between the calibration apparatus and the measuring device. Alternatively, communication can be wired.

A further preferred embodiment of the method provides for the number and/or the respective calibration standards used for calibration to be selected by the control device of the measurement device on the basis of the selected measurement task. This can prevent a mix-up of calibration standards or incorrect calibration due to a reduced number of calibration standards.

According to a preferred embodiment of the method, a carrier equipped with calibration standards is selected for the subsequent measuring task of the measuring device. The carrier can be permanently provided in a pre-assembled calibration apparatus. The calibration apparatus can also be equipped with a selected carrier comprising a sorting of calibration standards or the selected sections of the carrier can be equipped with predetermined calibration standards. In the case of series production, it may be provided for quality control that, for example, several pre-assembled calibration apparatus are used in order to save time for preparing the calibration apparatus for the calibration task. Alternatively, it is also possible to select a calibration apparatus with a carrier in which the individual sections can be individually fitted with calibration standards in the case of individual and a large number of different measurement tasks.

Furthermore, it is preferable that at least a predetermined number of sections are recorded with the respective calibration standards of the calibration apparatus and stored in the control unit of the measuring device.

Furthermore, it is preferable for the calibration of the measurement device to be controlled by the control device of the measurement device and for the calibration standards selected for the measuring task to be transferred to the measuring position one after the other. This allows a reliable and traceable calibration to be carried out.

In particular, it is provided that after the calibration of the measurement device has been performed with the at least one calibration standard of the calibration apparatus, a verification standard that was not used for the calibration of the measurement device is transferred to the measuring position and the calibration value is compared with the verification value of the verification standard. This allows an additional adjustment to be carried out for the calibration performed. In particular, it is possible to monitor whether there were any external influences during the calibration of the measuring device, such as temperature fluctuations, which could have led to a falsification of the calibration of the measuring device.

Furthermore, it is preferable that after the verification value has been recorded, a measurement object is measured by placing it on a pinhole or a pinhole of the carrier covered with a film and a reference value is then recorded and a difference between the verification value and the reference value is then determined. If the reference value is smaller than a specified threshold value, the calibration can be completed and the measurement device can then be activated for the measuring task. If the reference value is greater than a specified threshold value, a request can be made to repeat the calibration.

According to a further advantageous embodiment of the method, it may be provided that the calibration apparatus comprises a measuring support which is positioned behind the support in a primary beam directed at the support and that the support with a pinhole and an at least predetermined number of sections with calibration standards is moved to the measuring position for calibration after one or more measurements of measurement objects on the measuring support. This arrangement makes it possible, for example, for a calibration to be carried out automatically after each measurement or after a predetermined number of measurements during a test of a batch of measurement objects in order to start a recalibration in the event of a possible deviation of the measuring device.

Furthermore, it may preferably be provided that the carrier arranged in the calibration apparatus is replaced and a changer for measurement objects is used. Such a changer for measurement objects is designed in the same way as the carrier, but a predetermined number of measurement objects can be placed on it so that the measurement device can automatically trigger a successive measurement of measurement objects via the calibration apparatus.

The invention and other advantageous embodiments and further embodiments thereof are described and explained in more detail below with reference to the examples shown in the drawings. The features to be taken from the description and the drawings can be used individually or in any combination in accordance with the invention. It shows:

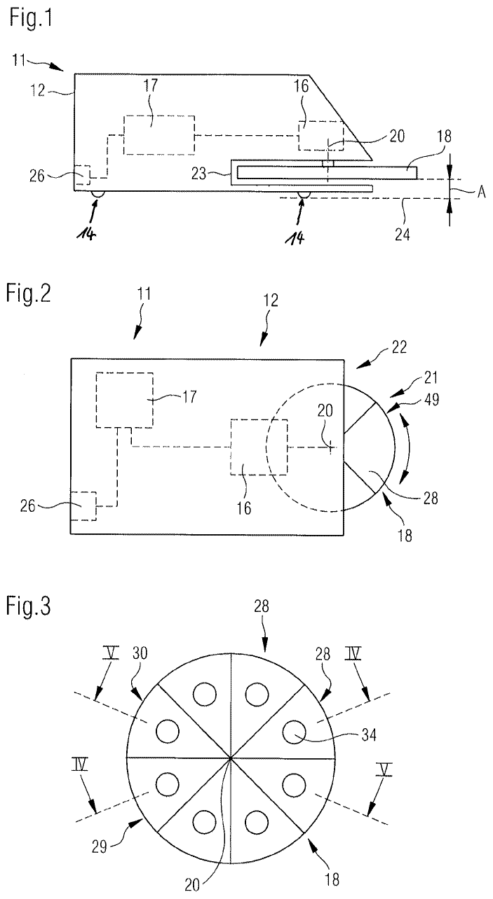

FIG. 1 a schematic side view of a calibration apparatus,

FIG. 2 schematic view from above of a calibration apparatus according to FIG. 1,

FIG. 3 a schematic view from above of a carrier of the calibration apparatus according to FIG. 1,

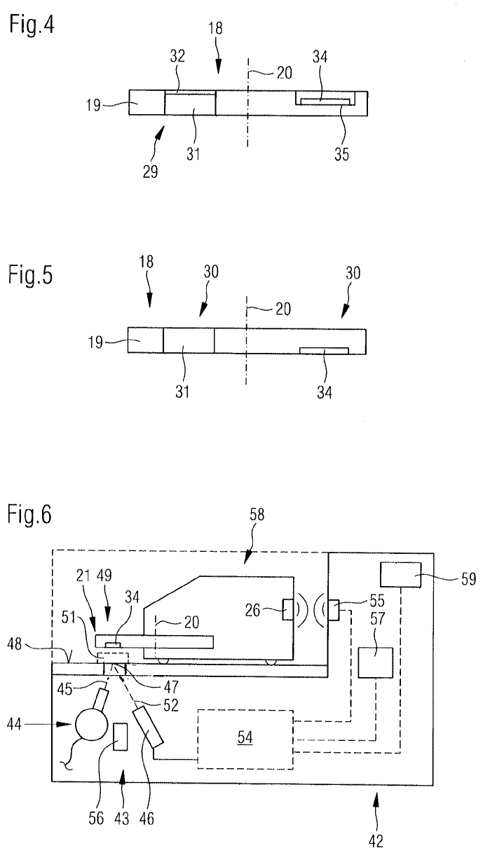

FIG. 4 a schematic sectional view of a section of the carrier as shown in FIG. 3,

FIG. 5 a schematic sectional view along line V-V of the carrier in FIG. 3,

FIG. 6 a schematic side view of the calibration apparatus in a calibration position relative to the measuring device,

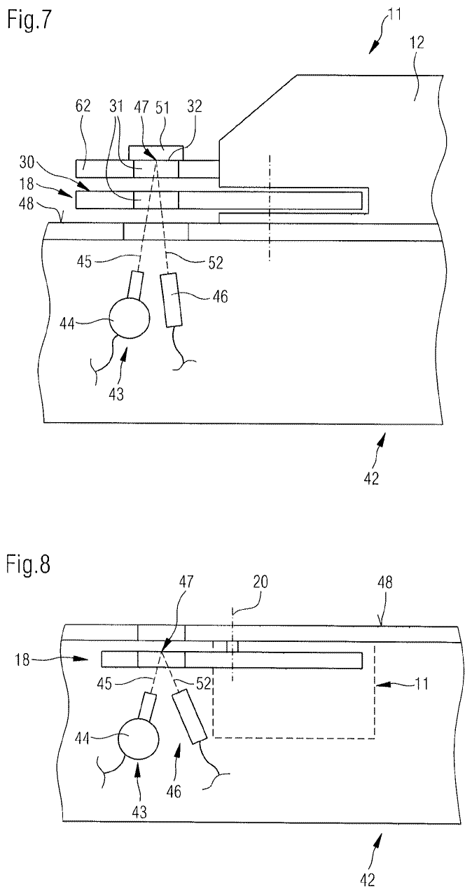

FIG. 7 a schematic side view of an alternative embodiment to FIG. 6, and

FIG. 8 a schematic side view of a further alternative embodiment to FIG. 6.

FIG. 1 shows a schematic side view of a calibration apparatus 11. A top view of the calibration apparatus 11 is shown in FIG. 2. This calibration apparatus 11 comprises a housing 12. A support surface or support points 14, which lie in a support plane 24, are provided on an underside of the housing 12 for positioning on a surface. The housing 12 comprises a drive 16, in particular an electric motor, which is rotatably driven by a control unit 17. This drive 16 controls the movement of a carrier 18 relative to the housing 12. This carrier 18 has a base body 19, which is in the form of a rotating disk, for example. The axis of rotation 20 of the support 18 is preferably aligned perpendicular to the support plane 24 of the support points 14. The carrier 18 is arranged in a position relative to the housing 12 such that an arcuate segment-shaped section 21 of the carrier 18 protrudes from an end face 22 or a front face of the housing 12. The further part of a carrier 18 is positioned within an open receptacle 23 in the housing 12. It is preferably provided that a distance between the support 18 or an underside of the support 18 and a support plane 24 formed by the support points 14 or a support surface of the housing 12 has a distance A which is less than 10 mm, preferably less than 5 mm, in particular less than 3 mm.

A data interface 26 is provided on or in the housing 12 of the calibration apparatus 11, which is connected to the control unit 17. The data interface 26 can have a mechanically designed plug connection for wired communication and/or for a power supply. The data interface 26 can also be designed as a wireless communication interface. In this case, the calibration apparatus 11 can have a separate power supply to a mains supply or be operated with rechargeable batteries.

The carrier 18 of the calibration apparatus 11 according to FIGS. 1 and 2 is shown in a plan view in FIG. 3. This carrier 18 has a plurality of sections 28. These sections 28 are preferably evenly distributed around the circumference. In this case, the sections 28 can have the same size. For example, they can be in the shape of a pie slice. This section 28 of the carrier 18 can be equipped with a calibration standard 34. This calibration standard 34 can be permanently integrated in the carrier 18. Alternatively, a receptacle 35 can be provided in the section 28 for positioning the calibration standard 34. This receptacle 35 can be in the form of a recess, as shown in FIG. 4, which shows a sectional view along line IV-IV in FIG. 3. A calibration standard 34 can be inserted into this receptacle 34. Furthermore, the carrier 18 can also be designed to hold a measurement object. In this case, for example, it can be a section 29 which comprises a perforated aperture 31 covered by a film, in particular Mylar film 32, as shown in FIG. 4. Thus, a measurement object can be placed on the upper side of the carrier 18 or the foil 32, which is smaller in diameter than the perforated aperture 31. Furthermore, a section 30 can be formed in the carrier 18, as shown in a sectional view along the line V-V according to FIG. 3 in FIG. 5. This section 30 can only consist of a perforated aperture 31. The perforated aperture 31 represents a through-hole with a free passage. In the sectional view along the line V-V according to FIG. 3, an alternative embodiment and arrangement of the calibration standard 34 to the carrier 18 is shown. In this arrangement, the calibration standard 34 is firmly arranged or integrated in the base body 19 of the carrier 18.

The carrier 18 is rotatably mounted about the vertical axis 20. It may be provided that the carrier 18 is interchangeably arranged in the housing 12 and can be coupled to the drive 16. For example, the carrier 18 can have indexing so that it can be connected to a drive shaft of the drive 16 in a defined alignment. The drive 16 itself can comprise a position encoder so that the position and orientation of the indexing of the drive shaft is known to the control unit 17. As a result, a defined positioning of the individual sections 28, 29, 30 in a measuring position 49 (FIGS. 2 and 6) can be controlled by means of the control unit 17 of the calibration apparatus 11. In this measuring position 49, a sufficient area of each section 28, 29, 30 of the carrier 18 protrudes from the end face 22 of the housing 12.

The base body 19 of the carrier 18 preferably consists of a thermoplastic material without additives that lead to absorption and/or reflection of the X-rays. Polyethylene, polycarbonate or polymethyl methacrylate is preferred.

The calibration standard 34 can be designed as a so-called pure element in order to calibrate a measurement device 42, in particular an X-ray fluorescence measurement device as shown in FIG. 6, for material analysis. Such pure elements can consist of precious metals with a very high degree of purity. The calibration standard 34 can also be designed as a base body with a coating in order to calibrate the measurement device 42 for a coating thickness analysis. The calibration standard 34 may comprise an identification code, such as a QR code or barcode.

FIG. 6 shows a schematic side view of the measurement device 42.

This measurement device 42 is an X-ray fluorescence measuring device. This measurement device 42 comprises an X-ray fluorescence device 43, which comprises a radiation generation source 44 for generating X-rays and at least one detector 46. The radiation generation source 44 emits a primary radiation 45, which is directed onto a measuring point 47 in a measuring surface 48 of the measurement device 42. The secondary radiation 52 emitted by a measuring object 51 resting on the measuring point 47 or a calibration standard 34 on the carrier 18 is detected by the detector 46 to determine measured values. These measured values are forwarded to a control device 54 of the measurement device 42. This control device 54 is connected to a data interface 55.

Furthermore, an optical device 56 is shown schematically in the measurement device 42. This optical device 56, in particular a camera, captures images of the measuring point 47 via a mirror, not shown in detail, which is coupled into the beam path in order to take images of the measuring point 47.

The calibration apparatus 11 is separate from the measurement device 42, in particular the measurement device 42 for coating thickness analysis. The calibration apparatus 11 can be used for the consecutive calibration of several measuring devices 42. The calibration apparatus 11 is designed to be detachable from the measurement device 42. The calibration apparatus 11 is an independent unit. To calibrate the measurement device 42, the calibration apparatus 11 is moved into a calibration position 58 on or in the measurement device 42. In this calibration position 58, the calibration apparatus 11 is preferably positioned on the measuring surface 48 of the measurement device 42. An arcuate segment-shaped section 21 of the carrier 18 protrudes from the housing 12 of the calibration apparatus 11 and is aligned with the measuring point 47 of the measurement device 42, so that the primary radiation generated by the radiation source 44 impinges on the sections 28, 29, 30 of the carrier 18, which can be aligned with the measuring point 47.

A positioning laser provided on or in the measurement device 42 or the optical device 56 can be provided to align the calibration apparatus 11 with the measuring point 47 in the measurement device 42. In the case of the optical device 56, the position of the section 28 of the carrier 18 relative to the measuring point 47 is output, for example, in a display 57 of the measurement device 42. An acoustic signal can also be emitted.

Furthermore, in the calibration position 58, wireless or wired communication is established between the control unit 17 of the calibration apparatus 11 and the control unit 54 of the measurement device 42.

Calibration of the measurement device 42 by the calibration apparatus 11 can be carried out as follows: At a control panel 59 of the measurement device 42, which can also be designed separately from the measurement device 42 in the form of a portable communication device, in particular a tablet, an operating software in the control device 54 is used to select a measurement task of the measurement device 42 to be carried out subsequently. The control device 54 outputs the corresponding number of calibration standards 34 and/or types of calibration standards 34 for this purpose.

The calibration apparatus 11 can comprise a pre-assembled carrier 18, which includes the calibration standards 34 required for the calibration task. Alternatively, a carrier 18 can also be equipped with corresponding calibration standards 34. Alternatively, the carrier 18 can also be replaced by a further carrier for the housing 12 of the calibration apparatus 11, which comprises the calibration standards for the subsequent measurement task.

The control unit 17 of the calibration apparatus 11 then transmits information to the control unit 54 of the measurement device 42 about the sections 28, 29, 30 of the carrier 18 aligned with the measuring points 47 in a measuring position 49. The calibration process is then started by the control unit 54 of the measurement device 42, in which the individual sections 28, 29, 30 are selected in order to carry out the corresponding measurements for the calibration. For example, several sections 28 are controlled with calibration standards 34 that differ from each other. The calibration standard 34 can be assigned to the measured values for determining the calibration value from the position detection of the sections 28, 29, 30 to the measuring position 49.

The respective section 28, 29, 30 in the measuring position 49 can be recognized by the control unit 17, provided that the carrier 18 has been aligned with the drive 16 in the calibration apparatus 11. Likewise, an identification code of the calibration standard 34 or in the section 28, 29, 30 can be queried by the measurement device 42 or the calibration apparatus 11 for recognition.

After the predetermined number of calibration standards 34 have been measured for the subsequently selected measurement task and calibration values have been recorded for each of them, these are compared with the standard values stored in the control device 57 and correction values are then determined, which are taken into account during the subsequent measurement of measurement objects. The calibration apparatus 11 can be removed from the calibration position 58 for the subsequent measurement task, which is carried out with the measurement device 42. The measurement objects can then be placed on the measurement point 47 one after the other and individual measurements can be carried out and saved.

Alternatively, the carrier 18 can also be replaced by a changer for holding measurement objects in the calibration apparatus 11. Subsequently, the further clocking or positioning of the measurement objects on the changer can be controlled by the control 17 of the calibration apparatus 11 or by the control device 54.

The calibration of the measurement device 42 by the calibration apparatus 11 may also comprise a further step. After recording the calibration values from the predetermined number of calibration standards 34 in the respective sections 28 of the carrier 18, the carrier 18 can be transferred to the measuring position 49, for example with the section 29 or the section 30. A reference object is then placed on the pinhole 31 or on a foil 32 covering the pinhole 31 and a measurement is carried out. This reference object or reference standard has not previously been used to calibrate the measurement device 42. However, this reference object is standardized in the same way as the calibration standards 34. The reference value determined can then be compared with the calibration value. If there is a difference value that is greater than a predefined threshold value, a new calibration should be carried out. If this difference value is smaller than a threshold value, the calibration can be considered to have been carried out correctly.

FIG. 7 shows an alternative embodiment of the calibration apparatus 11 in the calibration position 58 relative to the measurement device 42. In this calibration apparatus 11, a measuring support 62 is provided adjacent to the carrier 18. This measuring support 62 can be detachably fastened to an end face 22 of the housing 12. The measuring support 62 preferably comprises a perforated aperture 31, which is covered in particular with a foil 32, on which the measuring object 51 can be positioned. The film 32 is preferably a Mylar film. After calibration of the measurement device 42 with the calibration apparatus 11, the calibration apparatus 11 remains in the calibration position 58 relative to the measurement device 42. The carrier 18 is aligned with the section 30 to the measuring point 47. The primary radiation of the X-ray fluorescence measurement device 43 directly hits the underside of the foil 32 of the measuring support 62, on which the measuring object 51 rests. The resulting measured values can be recorded directly by the detector 46. If a calibration is now to be carried out between a measurement or a plurality of measurements of a batch of measurement objects 51, the calibration apparatus 11 can be controlled so that the individual sections 28 are positioned at the measuring point 47 for the acquisition of calibration values. This arrangement makes it possible, for example, to perform a calibration, a measurement and a calibration, etc. It can also be provided that a calibration, a predetermined number of measurements and another calibration are performed.

FIG. 8 shows a further schematic sectional view of an alternative embodiment of the measurement device 42 and the calibration apparatus 11. In this embodiment, the calibration apparatus 11 is integrated into the measurement device 42. It is provided that the carrier 18 of the calibration apparatus 11 is positioned below the measuring surface 48, i.e. between the measuring point 47 and the X-ray fluorescence device 43. All of the aforementioned embodiments and alternatives are also possible in this alternative embodiment. This arrangement has the particular advantage that in the case of very thin foils used for the calibration standard 34, a small distance to the X-ray fluorescence device 43 is created, whereby a maximum intensity for the signal acquisition for the evaluation of the measured values is made possible. For equipping the carrier 18 and/or replacing it, the measuring surface 48 can be at least partially hinged or removable, for example, so that the calibration apparatus 11 integrated in the measurement device 42 can be easily accessed.

1. Calibration apparatus for a measuring device for material analysis or coating thickness analysis,
with a housing,
having a carrier which comprises a plurality of sections, arranged in a row, at least one calibration standard being provided in at least one section,
with a drive by means of which the sections of the carrier are moveable alternately or successively into a measuring position, and the drive has a position transmitter and one of the sections is aligned with the position transmitter in a starting position and the individual sections are transferrable to the measuring position in a defined manner by the detection of the angle of rotation or of increments by the position transmitter,
with a control unit which controls the drive for moving the carrier, and
with a data interface, which is connected to the controller and which communicates with a data interface of the measurement device to be calibrated.

2. (canceled)

3. Calibration apparatus according to claim 1, wherein at least one section of the carrier has an identification code, which is readable out by an optical device on the housing or on the measurement device and the respective identified section is transferrable to the measuring position by the controller.

4. (canceled)

5. Calibration apparatus according to claim 1, wherein the carrier has a base body which is designed as a rotating disc which has a plurality of sections distributed over the circumference, and preferably a plurality of sections are provided distributed uniformly over the circumference.

6. Calibration apparatus according to claim 1, wherein the carrier has, in at least one section, a receptacle for positioning the calibration standard or has a support surface for a measurement object, and/or in that the carrier has a pinhole in the section, and the pinhole is covered with a film in the section.

7. Calibration apparatus according to claim 1, wherein the carrier has an unchangeable assembly of calibration standards in the sections.

8. Calibration apparatus according to claim 1, wherein the carrier is provided interchangeably with the drive in the housing.

9. (canceled)

10. (canceled)

11. Calibration apparatus according to claim 1, wherein the data interface in the housing is designed for wireless or wired communication with the measurement device.

12. Calibration apparatus according to one claim 1, wherein the carrier is rotatably mounted in the housing by a vertical axis and is accommodated in an X/Y plane parallel to the measuring surface of the measurement device.

13. Calibration apparatus according to claim 1, wherein the carrier projects with an arcuate-segment-shaped section opposite an end face of the housing or in that the carrier is provided completely inside the housing and the sections of the carrier are accessible from the outside through a housing opening in the housing.

14. Calibration apparatus according to claim 1, wherein the housing has a support surface or support points which form a support plane, and in that a measuring point or a measuring surface of the calibration standard or of the measurement object on, on or in the support is at a distance of less than 10 mm, or of less than 5 mm, or of less than 3 mm, from the support plane.

15. (canceled)

16. Method for calibrating a measurement device for material analysis or coating thickness analysis,
in which a measuring task to be performed subsequently is selected in a control device of the measurement device,
in which a calibration apparatus according to claim 1 is arranged in a calibration position relative to the measurement device to be calibrated, at least one section of the carrier of the calibration apparatus in the calibration position is aligned with a measuring point in a measuring surface of the measurement device and
in which a data interface of the calibration apparatus communicates with a data interface of the measurement device in order to calibrate the measurement device.

17. Method according to claim 16, wherein individual calibration standards arranged in the sections of the carrier, which are selected for the subsequent measurement output by the control device, are moved in the calibration apparatus into a measurement position relative to the measurement device and a calibration measurement is carried out,
in that the measurement data determined from the calibration standard arranged in the respective section of the carrier is forwarded to the control device and a calibration value is determined from each calibration standard, and
that the standard values stored in the control device are compared with the calibration values and correction values for the subsequent measuring task for the measurement device are determined and used as a basis.

18. (canceled)

19. Method according to claim 16, wherein the alignment of the calibration apparatus in the calibration position is carried out with a positioning laser of the measurement device or with a measurement image of an optical device of the measurement device.

20. (canceled)

21. Method according to claim 16, wherein the number and/or the respective type of the calibration standards is selected by the control device on the basis of the selected measuring task, a traversing movement of the carrier of the calibration apparatus for positioning the respective calibration standard in the measuring position is controlled.

22. Method according to claim 16, wherein a carrier equipped with calibration standards is selected or that the carrier is equipped with the respective selected calibration standards.

23. (canceled)

24. Method according to claim 16, wherein, after the calibration of the measurement device with the calibration standards of the calibration apparatus has been performed, a verification standard is transferred to the measurement position, which verification standard was not used for the calibration of the measurement device and a verification value is recorded by the verification standard and in that the measured value of the calibrated measurement device is compared with the verification value of the verification standard.

25. Method according to claim 24, wherein, after the detection of the verification value, a measurement is taken on a reference object by placing it on a pinhole in a section or on a pinhole spanned by the film in a section of the carrier and a reference value of the reference object is then compared with the verification value and, if the resulting difference value is greater than a threshold value, a recalibration is started.

26. Method according to claim 16, wherein in that a primary beam is directed onto the carrier of the calibration apparatus in the calibration position and a measuring support is positioned behind it in the beam direction of the primary beam for arranging a measuring object, and in that the carrier is provided with a section having a pinhole covered by a foil or with a section having a pinhole for detecting a measured value is positioned from the measurement object to the measurement point and after one or more measurements on measurement objects with at least one section having a calibration standard is moved to the measurement point for calibrating the measurement device.

27. Method according to claim 16, wherein in the calibration apparatus, the carrier is exchanged after the calibration and a changer for receiving measurement objects is inserted into the calibration apparatus and a successive positioning of the measurement objects in the measurement position for measuring the measurement objects is carried out by the calibration apparatus.
